(19) United States
(12) Patent Application Publication
(10) Pub. No.: US 2009/0211395 A1
(43) Pub. Date: Aug. 27, 2009

(54) Adjustable pedal system for exercise bike

(76) Inventor: Leonard Mul'e, Garfield, NJ (US)

Correspondence Address: KLAUBER & JACKSON, 411 HACKENSACK AVENUE, HACKENSACK, NJ, 07601, US

(21) Appl. No.: 12/072,213

(22) Filed: Feb. 25, 2008

(51) Int. Cl. B62M 3/02; A63B 22/06

(52) U.S. Cl. 74/594.7; 482/57

(57) ABSTRACT

An adjustable pedal system for changing the position of pedals along the crank arms of an exercise bike. The system provides a locking member, such as a rack, located along the crank arm and a locking member, such as one or more gear teeth formed on a slide sleeve to which the pedal is affixed. Thus the slide sleeve and pedal can be slid along the crank arm to the desired position whereupon the locking members intermesh to positively lock the pedal in the desired location. The intermeshing is maintained by a clamping device, such as a thumb screw that is tightened to lock the pedals in the desired location and loosened to disengage the locking members to allow the movement of the pedals to another location. The system can be operated without the need for tools and can be retrofitted to existing exercise bikes.

### BACKGROUND

The present invention relates to a system for adjusting the pedal location along a crank arm of an exercise bike, and, more particularly, to a simple, tool less system that allows a user to change the location of the pedals of an exercise bike along the crank arm to adjust the throw or radius of the rotational movement.

There are a number of differing exercise bikes currently available commercially. While there are certainly differences in such exercise bikes, in general, most have some frame with a crank mechanism having a center shaft that passes through the frame along a generally horizontal axis and having two crank arms that extend outwardly in parallel planes and spaced at 180 degrees apart. There are also pedals that are affixed in one manner or another to the crank arms such that the user can place both feet into the pedals and rotate the crank mechanism in a rotational movement for exercise, therapy or both.

In many of such exercise bikes, the throw, or radial distance that the pedals are located away from the rotational axis is fixed, however, there are real advantages to having the throw adjustable by the user.

The advantages of having an adjustable throw or radius are well known. For example, after a knee replacement surgery, the rehabilitation includes working out on an exercise bike to regain the strength and flexibility of the knee. A problem occurs, however, in that the normal throw or total radius of the rotational movement of the pedals is simply too great for many patients and it can overstress the replacement knee. In the case of exercise bikes, the present fixed pedal location of many such bikes has a rotation diameter of about 13 inches (33 cm.) and which makes it virtually impossible for the average patient to achieve a complete revolution of the pedals during the early phases of post operation rehabilitation.

It is, therefore, more advantageous to the patient to commence the rehabilitation with a shorter radius or throw and then, as the knee regains strength, gradually increase the throw during the rehabilitation process.

The ability to change the radius of the rotational movement of the pedals has been published, see U.S. Pat. No. 7,204,788 of Andrews and U.S. Pat. No. 5,338,272 of Sweeney, III however, in most cases, the mechanism or system is relatively complex, requires tools and/or specialized knowledge, and is limited in the ability to move the pedals along positive, multiple positions and the like. It is important that the ability to change the location of the pedals be simple since the average age of surgery patients for knee surgery is in the 60's and 70's and thus the adjustment must be real easy for such persons to accomplish.

It would therefore be advantageous to have an exercise bike having a pedal adjustment system that would allow the patient to easily and positively move the location of the pedals along the crank arm to differing positions. It would be further advantageous to provide a pedal adjustment system having no need for special tools to carry out the adjustment process. It would be still further advantageous to have a pedal adjustment system that provides the ability to position either or both pedals individually at multiple positions along the crank arm and be positively locked into the desired position.

### SUMMARY OF THE INVENTION

Accordingly, the present invention relates to a system for adjusting the location of pedals along the crank arm of a crank mechanism of an exercise bike in order to adjust the rotational radius of those pedals. The invention is shown and described as used with a recumbent exercise bike and the present invention is particularly useful with that type of exercise bike.

With the present pedal adjustment system, the pedals can be moved along the crank arm of a crank mechanism of an exercise bike to thereby adjust the throw or radius of rotational movement of the pedals about a main shaft of rotation.

The pedals can be located in a plurality of position along that crank arm, and at each selected location, there is a locking system that intermeshes a locking member on the crank arm and a locking member on a sleeve slide to which the pedal is affixed.

Once intermeshed, the locking members lock the pedals in the desired positions and that locked position is maintained by the use of a clamping device such as a thumb screw or knob that holds the locking members in that intermeshed condition. The thumb screw itself can be readily manipulated by the user without the need for special tools.

In an exemplary embodiment, one of the locking members can be a rack and the other a plurality of teeth that intermesh with the rack.

In another aspect of the present invention, there is commonly used during the rehabilitation of a knee, for example, a goniometer which measures the angle of the knee, that is, the angle between the upper leg and the lower leg. It is important to regain the flexibility of the leg to continue to improve that angle width and often the knee is stretched to a painful position in trying to maximize the angle that the patient is capable of attaining.

Accordingly, there is a system of the present invention that is built into or located proximate to the exercise bike that provides a continuous measurement of the angle of the knee while the patient is carrying out normal exercises on the bike.

To that end, the present invention includes a processor having an input of the patient's height, an input representative of the location of the seat on which the patient is resting and an input representative of the location of the pedal along the crank arm. With those parameters inputted to the processor, the processor can calculate the knee angle and there can be a display that lets the patient be aware of that angle as the exercise is being carried out.

These and other features and advantages of the present invention will become more readily apparent during the following detailed description taken in conjunction with the drawings herein.

### BRIEF DESCRIPTION OF THE DRAWINGS

FIG. 1 is a perspective view of an exercise bike incorporating the pedal adjustment system of the present invention;

FIG. 2 is an enlarged perspective view of a pedal used with the pedal adjustment system of FIG. 1 and FIG. 2A is an alternative embodiment thereof;

FIG. 3 is a side view, partly in cross section, showing the pedal adjustment system of the present invention;

FIG. 4 is a side cross sectional view showing the present pedal adjustment system in its locked position;

FIG. 5 is a side cross sectional view showing the present pedal adjustment system in its unlocked position;

FIG. 6 is a top view of the present pedal adjustment system;

FIG. 7 is a side view of the present pedal adjustment system;

FIG. 8 is an exploded view illustrating the components making up the present pedal adjustment system;

FIG. 9 is a schematic view illustrating the system to determine and display the angle of the knee during exercises on an exercise bike; and

FIG. 10 is a block diagram of the various functions of the FIG. 9 system.

### DETAILED DESCRIPTION OF THE INVENTION

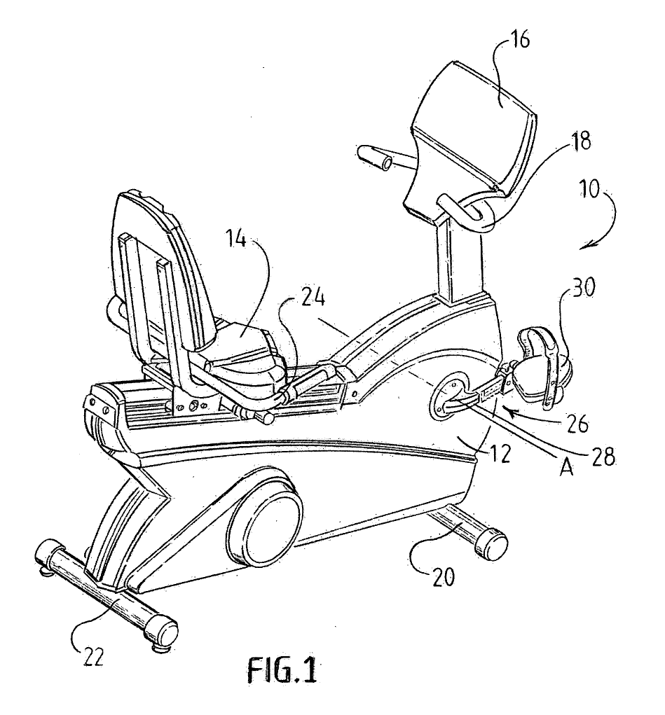

Referring now to FIG. 1, there is shown a perspective view of an exercise bike 10 having included, therewith the pedal adjustment system of the present invention. The illustration is that of a recumbent bike to which the present invention is particularly adapted. As can be seen, the exercise bike 10 comprises a frame 12 having various conventional components, such as a seat 14, a display panel 16 to view certain parameters of the exercise routine, handle bars 18 and base members 20, 22 to retain the exercise bike 10 in a stable upright orientation. As can be seen, the seat 14 is adjustable in accordance with the particular user and the seat adjustment can be accomplished in a conventional manner. A second set of handle bars 24 is present for use by a user when in a reclined position.

The exercise bike 10 also includes a crank mechanism 26 that includes a main shaft, not shown in FIG. 1, that passes through the frame along the horizontal axis A and a pair or crank arms. Only one crank arm 28 is shown in FIG. 1, with the other crank arm extending outwardly from the main shaft in a plane parallel to the crank arm 28 and offset 180 degrees therefrom. There is a pedal 30 affixed to each of the crank arms and, again, in FIG. 1, only the pedal 30 is shown affixed to crank arm 28. As such, only one side of the exercise bike 10 is illustrated in FIG. 1, it being understood that a similar crank arm and pedal is present on the other side of the exercise bide 10 as will later be seen. Since the other pedal adjustment system is the same, only the one side will be explained in detail.

Accordingly, as can now be seen, the user sits in the seat 14 with the user's leg extending to the pedal 30 to create the rotational motion with both of the pedals. The travel of that rotational movement is governed by the radius of the circle formed by the rotating pedal 30 and that radius or throw is the distance between the axis of rotation A of the main shaft rotating in the frame 12 and the location of the pedal 30.

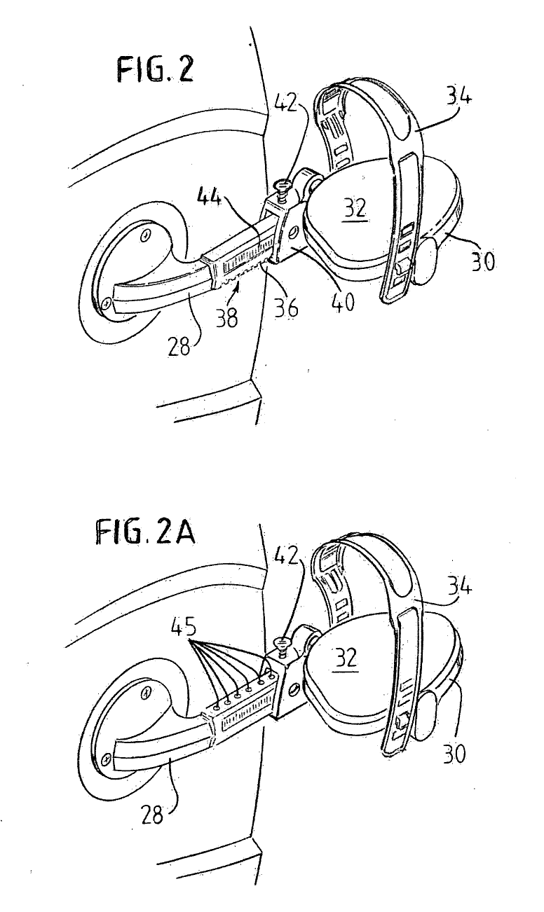

Turning now to FIG. 2, taken along with FIG. 1, there is shown an enlarged perspective view of the mechanism of the present pedal adjustment system. In FIG. 2, there can be seen the pedal 30 that is rotatably affixed to the crank arm 28 and the pedal 30 can include a foot pad 32 with a strap 34 to retain the foot of the user to the pedal 30. As also can be seen, the underside of the crank arm 28 has a plurality of locking members, shown in the form of indentations 36, forming a rack 38, and there is a sleeve slide 40 that is slidingly affixed to the crank arm 28 in order to reposition the pedal 30 in a manner that will later be explained. A thumb screw 42 is also provided and a linear scale 44, and the purpose of both of those components will also be later explained.

FIG. 2A illustrates an alterative embodiment of the FIG. 2 mechanism wherein there are a plurality of countersunk holes 45 bored in the crank arm 28 so that the thumb screw 42 can be seated in any of the countersunk holes 45 to lock the pedal 30 in any one of multiple positions available. With the countersunk holes 45, the thumb screw 42 itself can be a spring biased button that can be biased to a locked position.

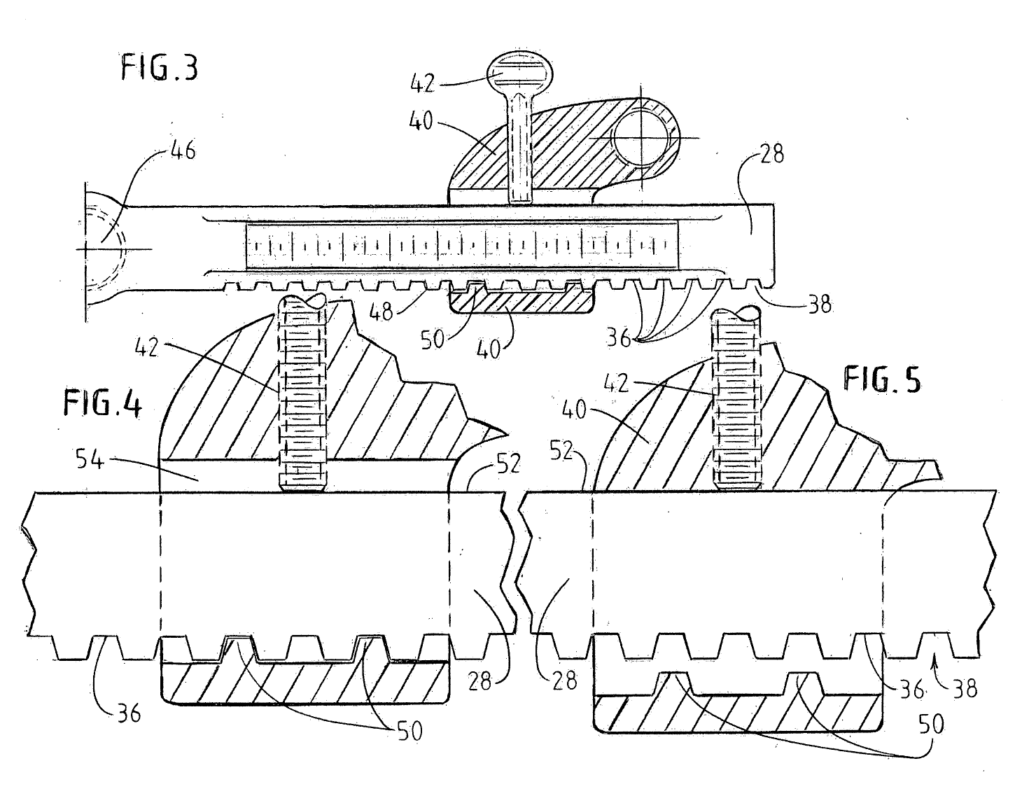

Turning now to FIG. 3, taken along with FIGS. 1 and 2, there is a side cross sectional view of the pedal adjustment system of the present invention. As can be seen, the crank arm 28 extends outwardly from the main shaft 46 that, in turn, is rotatable mounted to the frame 12. Along the lower surface of the crank arm 28, there is formed locking members in the form of the indentations 36 forming the rack 38.

That rack 38 can be formed on the crank arm 28 during the manufacture and fabrication of the crank arm 38 or can be affixed to the lower surface of a standard crank arm in order to retrofit the system of the present invention to an existing exercise bike. As will be later discussed, instead of a plurality of indentations 36 in the rack 38 or locking members, there can be at least one locking member formed as an indentation or projection located along the lower surface of the crank arm 28 consistent with the intent of the present invention.

Along a lower, upwardly facing surface 48 of the sleeve slide 40, there is also a plurality of locking members in the form of teeth 50 extending upwardly and which can be seen as meshing with the indentations 36 on the rack 38, thus prevents the sleeve slide 40 from moving along the crank arm 28. That meshing between the teeth 50 and the indentations 36 is maintained by a clamping device such as the thumb screw 42 that is threaded through the sleeve slide 40. As such, the user can tighten the thumb screw 42 to bring the teeth of the sleeve slide 40 into a fixed and locked engagement with the indentations 36 in the rack 38 to hold the pedal 30 in a fixed location along the crank arm 28. The term thumb screw will be used herein in the description, however, the term is intended to apply to any screw of clamping device that can be easily turned by an individual in making an adjustment to the pedal 30.

Turning to FIG. 4, taken along with FIGS. 1-3, it can be seen that the thumb screw 42 has been tightened against the upper surface 52 of the crank arm 28 such that the teeth 50 have drawn up and entered into and thus locked to the indentations 36 of the rack 38. Thus the sleeve slide 40 is in its locked position in FIG. 4. As also can be seen, when in the unlocked position of FIG. 4, there is a space 54 between the upper surface 52 of the crank arm 28 and the lower surface of the sleeve slide 40.

Turning to FIG. 5, taken along with FIGS. 1-4, the sleeve slide 40 is shown in its unlocked position and wherein the thumb screw 42 has been withdrawn or loosened, thereby allowing the sleeve slide 40 to fall away from its locked position of FIG. 4 intermeshing or locking to the crank arm 28 and, in this position, the sleeve slide 40 can be freely slid along the length of the crank arm 28 to locate the pedal 30 to a different position therealong. In this locked position of the sleeve slide 40, the space 54 of FIG. 4 has disappeared.

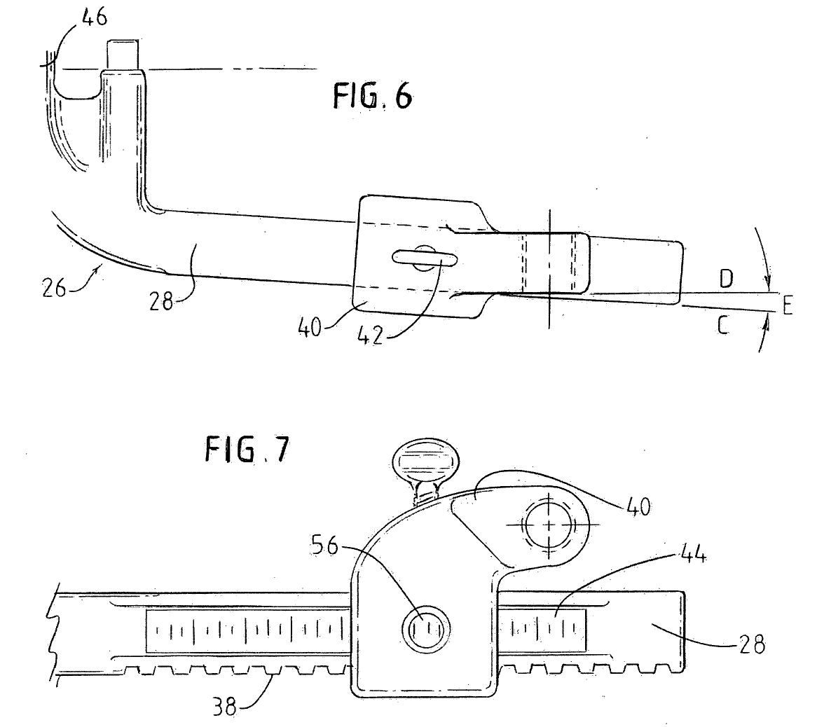

Turning next to FIG. 6, taken along with FIGS. 1-5, there is a top view illustrating the pedal adjustment system of the present invention. In this view, it can be seen that the sleeve slide 40 can move freely along the crank arm 28 to adjust to a desired position to change the throw or radius of movement of the pedals i.e. the distance between the pedals and the axis of the main shaft rotatably affixed within the frame. As is noted in FIG. 6, there is an angular offset between the longitudinal axis C of the crank arm and the longitudinal axis D of the sleeve slide 40 to which the pedal 30 is mounted and that angle is shown as angle E. That angle is generally about 4 degrees.

Turning briefly to FIG. 7, taken along with FIGS. 1-6, there is a side view of the pedal adjustment system and illustrating a scale viewing window 56 to allow a user to see the linear scale 44 and verify the throw or radius of rotation of the pedals. As such, the linear scale 44 can be graduated in tenths of an inch or centimeters and the user can verify that the pedal 30 is located at the desired location along the crank arm 28 to carry out the particular exercise.

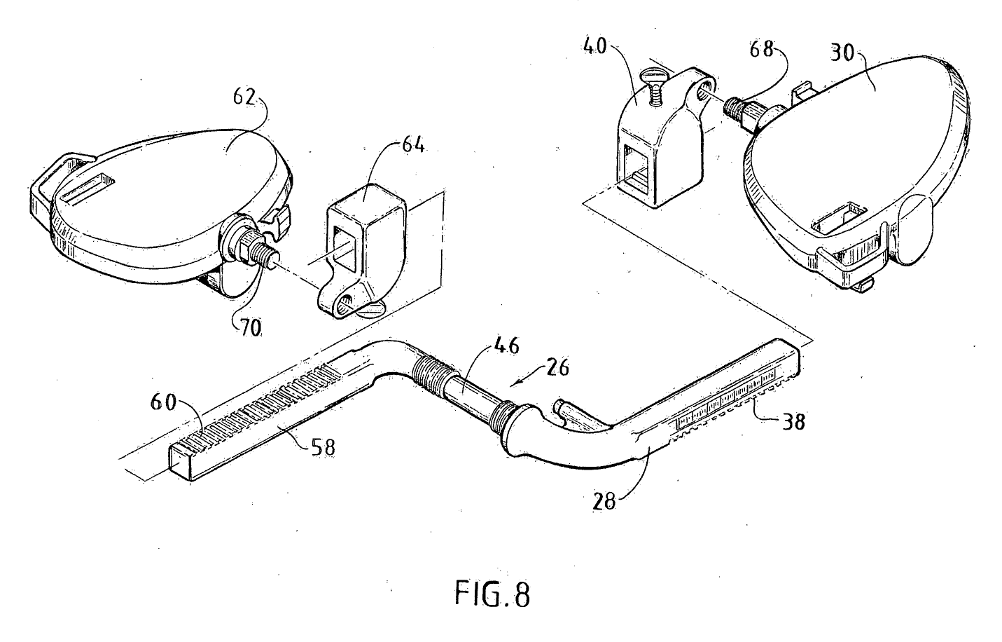

Turning to FIG. 8, taken along with FIGS. 1-7, there is an exploded view of the components of the present pedal adjustment system. As such the crank mechanism 26 can be seen having a crank arm 28 and a second crank arm 58 extending from the common main shaft 46 that is rotatably secured in the bike frame 12. As can be seen, in the case of crank arm 28, the rack 38 is located along the one surface of that crank arm 28 and with the crank arm 58, the rack 60 is located on the opposite surface.

Other components include the pedals 30 and 62 that are affixed to the sleeve slides 40, 64 respectively, by means such as threaded screws 68, 70 respectively.

In the use of the present invention to adjust the pedal movement, it is preferred that the pedal adjustment be undertaken when the pedal is located in its position furthest away from the user such that the rack 38 or 60 will be in a downwardly facing orientation i.e. the orientation of pedal 30 of FIG. 8. In such orientation, upon loosening of the thumb screw 42, the slide sleeve 40 will fall downwardly by gravity so as to easily disengage the slide sleeve 40 from the track 38.

Accordingly, it can be seen that the present pedal adjustment system can be used to adjust the radius or throw of the rotational movement of the pedals in a positive manner and yet without the need for tools or the like.

Accordingly, as can now be seen, there is a least one locking member, and preferable two locking members, on the slide sleeve and a plurality of locking members on the crank arm or, alternatively, there can be at least one locking member on the crank arm and a plurality of locking members formed on the slide sleeve. Either locking member can comprise gear teeth or a rack into which the gear teeth intermesh.

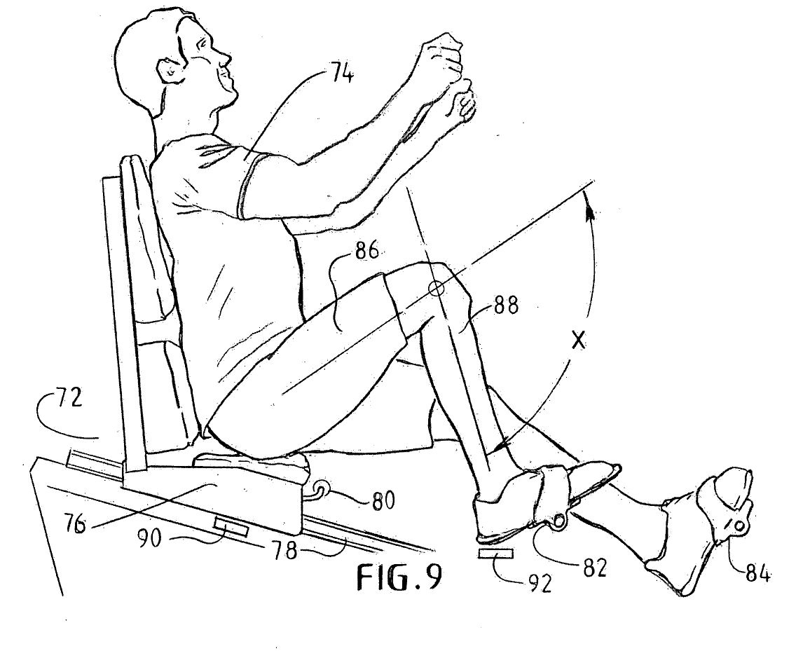

Turning now to FIG. 9, taken along with FIG. 1, there is shown a schematic view of a system of the present invention to determine the angle of the knee during exercise on the recumbent exercise bike 72. As can be seen, the patient 74 is positioned on a seat 76 of the recumbent exercise bike 72 and the seat 76 can be moved to a plurality of locations along a track 78 by a locking device such as handle 80 to suit the patient 74. In the position illustrated in FIG. 9, the pedals 82, 84 can also be seen to be in a position such that the pedal 82 is in its back position, or closest to the patient 74 while pedal 84 is in its front position, away from the patient 74.

As such, there is an angle X formed between the longitudinal axes of the upper leg 86 and the lower leg 88 and is the angle that is normally measure by a goniometer. The angle is indicative of the flexibility of the knee and thus the stage of rehabilitation of the knee following surgery. In FIG. 9 the angle X is shown to be about 110 degrees.

In any event, the angle X is measured to continually monitor the flexibility of the knee following surgery and is often a painful process to try to stretch the knee to achieve the maximum angle possible for the patient.

With the present invention, however, the angle X can be readily calculated and displayed to the patient or other persons on a continual, intermittent or “on demand” basis. The angle X is calculated automatically by use of a number of measured points, that is, the location of the seat 76, the location of the pedal 82 when in its back position and the height of the patient. The former two parameters can be determined by sensors and the height of the patient 74 can be inputted to a processor by the patient or attendant.

Accordingly, there is a seat position sensor 90 that senses and provides a signal indicative of the location of the seat 76 along the track 78. There is also a position sensor for the pedal 82 and may include a pedal sensor 92 that determines the location of the adjustable pedal 84 along the crank arm 28 (FIG. 1) as well as a rotational position of the crank arm 28 (FIG. 1) such that the position of the pedal 82 is accurately determined at its back location as shown in FIG. 9.

With those three data points, a processor can calculate the angle X and display that angle by means of a display located on the display panel 16 (FIG. 1).

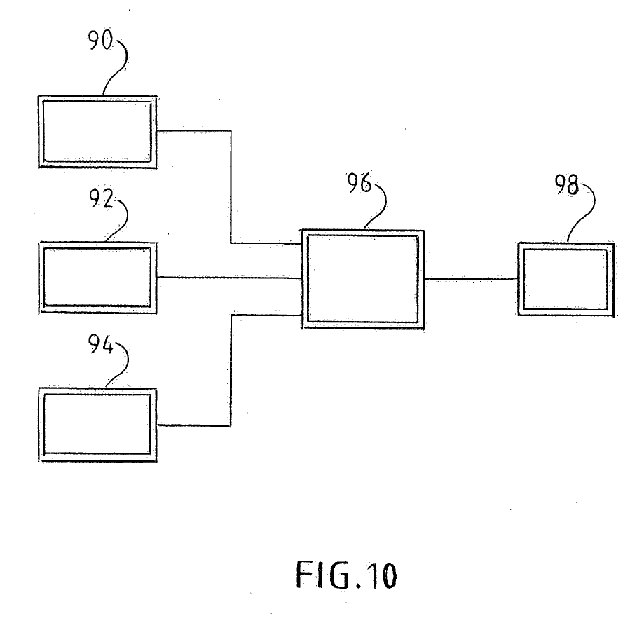

Turning finally to FIG. 10, taken along with FIG. 9, there is shown a block diagram illustrating the various functions of the angle determining system of the present invention and, as can be seen, the seat position sensor 90 determines the location of the seat 76 and sends a signal indicative of that location to the processor 96. In a similar manner, the pedal sensor 92 determines the location of the pedal 82 and sends a signal indicative of that location to the processor 96. There is an input device 94, such as a keyboard, that can be used to input the height of the patient and send a signal from that input device 94 indicative of the height of the patient to the processor 96.

As such, with the three items of data, the processor 96 can calculate the angle X indicative of the flexibility of the knee of the patient and send that information to a display 98 to show that angle to the patient and/or to attending personnel to assess the rehabilitation of the patient.

Those skilled in the art will readily recognize numerous adaptations and modifications which can be made to the pedal adjusting system of the present invention which will result in an improved system to allow the adjustment of the throw or radius of rotational movement of the pedals of an exercise bike, yet all of which will fall within the scope and spirit of the present invention as defined in the following claims. Accordingly, the invention is to be limited only by the following claims and their equivalents.

We claim:

1. An exercise bike having a system to adjust the location of pedals along a crank arm, the exercise bike comprising a frame, a crank mechanism mounted to the frame and having a main shaft rotatable about an axis of rotation and a pair of crank arms extending outwardly from the main shaft, each of the crank arms having at least one locking members formed along each crank arm, a pair of slide sleeves having a pedal affixed thereto, each of the slide sleeves being movably affixed to one of the crank arms, the slide sleeves having at least one locking member formed thereon therefrom adapted to intermesh with the at least one of the locking members on the crank arms to retain the pedals at desired locations along each crank arm and a clamping device to releasable maintain the locking members of the crank arms and the locking members of the slide sleeves intermeshed together.

2. The exercise bike of claim 1 wherein the locking member of the crank arms has a plurality of indentations

3. The exercise bike of claim 1 wherein the locking members of the slide sleeve has a plurality of projections.

4. The exercise bike of claim 2 wherein the locking member on the crank arm is a rack and the locking member on the slide sleeve is a plurality of teeth that are adapted to intermesh positively with the rack.

5. The exercise bike of claim 1 wherein a linear scale is provided on the crank arm to determine the position of the pedals.

6. The exercise bike of claim 6 further including a window formed in the slide sleeve through which the linear scale can be viewed.

7. The exercise bike of claim 1 wherein the clamping device comprises a thumb screw threaded engaged with the slide sleeve and bearing against the crank arm.

8. The exercise bike of claim 1 wherein the crank arm has a plurality of countersunk holes and wherein the clamping device enters into one of the plurality of countersunk holes.

9. The exercise bike of claim 1 wherein the bike is a recumbent bike.

10. A method of adjusting the position of a pedal along the crank arm of an exercise bike, the method comprising the steps of:
providing a slide sleeve that is slidably affixed to the crank arm, the slide sleeve having at least one locking member formed thereon and having the pedal affixed thereto;
providing at least one locking member on the crank arm that is adapted to intermesh and lock with the locking member of the crank arm;
moving the slide sleeve with the pedal to a desired location along the crank arm;
intermeshing the locking members on the crank arm and the slide sleeve to prevent movement therebetween; and
clamping the locking members of the crank arm and the slide sleeve together to maintain the pedal in a locked position along the crank arm.

11. The method of claim 10 wherein the step of clamping the locking members comprises drawing the locking members together by means of a thumb screw.

12. The method of claim 10 wherein the step of providing at least one locking member on the crank arm comprises providing a plurality of indentations of the crank arm.

13. The method of claim 10 wherein the step of providing a slide sleeve having at least one locking member comprises providing a slide sleeve having a plurality of teeth formed therein.

14. The method of claim 10 further including the step of disengaging the locking members of the crank arm and the slide sleeve by unscrewing the thumb screw.

15. A system for adjusting the location of a pedal along a crank and, the system comprising:
a crank arm having at least one locking member formed along the length of the crank arm;
a slide sleeve having a pedal affixed thereto, the slide sleeve being movably affixed to the crank arm, the slide sleeve having at least one locking member formed thereon therefrom adapted to intermesh with the at least one of the locking member on the crank arm to retain the pedal at desired location along the crank arm and a clamping device to releasable maintain the locking member of the crank arm and the locking member of the slide sleeves intermeshed together.

16. The system of claim 15 wherein the locking member on the crank arm has a plurality of indentations.

17. The system of claim 15 wherein the locking member of the slide sleeve has a plurality of projections.

18. The system of claim 15 wherein the locking member on the crank arm is a rack and the locking member on the slide sleeve is a plurality of teeth that are adapted to intermesh positively with the rack.

19. The system of claim 15 wherein a linear scale is provided on the crank arm to determine the position of the pedals.

20. The system of claim 19 further including a window formed in the slide sleeve through which the linear scale can be viewed.

21. A system to determine and angle between the upper leg and the lower leg of a patient positioned on a recumbent exercises bike having a seat for supporting a patient and a pedal for positioning a foot of a patient, the system comprising:
a pedal sensor for sensing the location of the pedal and producing a signal indicative of the pedal location;
a seat sensor for sensing the location of the seat and producing a signal indicative of the seat location;
an input device for inputting the height of the a patient and producing a signal indicative of the height,
a processor for receiving the signal from the pedal sensor, the seat sensor and the input device and calculating the angle between the upper leg and the lower leg of a patient using the recumbent exercise bike.
